(19) United States
(12) Patent Application Publication
(10) Pub. No.: US 2009/0210262 A1
(43) Pub. Date: Aug. 20, 2009

(54) METHODS AND APPARATUS FOR AUTOMATED TRAVEL

(75) Inventors: Clark C. Rines, Mesa, AZ (US); Satish Bhagavatula, Chandler, AZ (US); Stephen K. Brasher, Chandler, AZ (US); Manish Rao, Phoenix, AZ (US)

Correspondence Address: THE NOBLITT GROUP, PLLC, 4800 NORTH SCOTTSDALE ROAD, SUITE 6000, SCOTTSDALE, AZ, 85251, US

(73) Assignee: Remotian Systems, Inc. (Delaware Corporation)

(21) Appl. No.: 12/242,661

(22) Filed: Sep. 30, 2008

Related U.S. Application Data
(60) Provisional application No. 61/028,964, filed on Feb. 15, 2008.
(60) Provisional application No. 61/085,684, filed on Aug. 1, 2008.

(51) Int. Cl. G06Q 10/00

(52) U.S. Cl. 705/5

(57) ABSTRACT

Methods and apparatus for arranging travel according to various aspects of the present invention operate in conjunction with one or more computers. The computer may automatically identify appointment data associated with a scheduling application. The computer automatically researches one or more travel arrangements according to the appointment data.

### CROSS-REFERENCES TO RELATED APPLICATIONS

This application claims the benefit of U.S. Provisional Patent Application No. 61/028,964, filed Feb. 15, 2008, and U.S. Provisional Patent Application No. 61/085,684, filed Aug. 1, 2008, and incorporates the disclosure of each application by reference.

### BACKGROUND OF INVENTION

Many web-based travel systems have been developed. These systems are targeted toward both the consumer and business travelers. Most of these systems allow the user to search for travel and pricing options, prompt the user to make selections, and then utilize web-based credit card processing to complete the transaction for the travel arrangements. Generally, the information pertaining to the date, time and location of a trip must be entered by the user of such systems. The user or a proxy for the user must manually enter the trip information, obtain approval for such trips, pay for the travel arrangements, and then finally obtain a travel itinerary.

Some solutions attempt to automatically inform travelers of their trip reservations or changes to their trip reservations via web or wireless technologies, but are not capable of dynamically making changes on their own if the meeting or trip changes. In these cases, the user is required to manually initiate the travel arrangements. These systems also are not capable of adjusting the traveler's schedule to avoid conflicts with other travel plans or other meetings or events which may already be on their calendars.

### SUMMARY OF THE INVENTION

Methods and apparatus for arranging travel according to various aspects of the present invention operate in conjunction with one or more computers. The computer may automatically identify appointment data associated with a scheduling application. The computer automatically researches one or more travel arrangements according to the appointment data.

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1 is a diagram of an automated travel system according to various aspects of the present invention configured to interact with a scheduling application and various information sources;

FIG. 2 illustrates a data flow for interaction of a user with the automated travel system;

FIG. 3 is a block diagram of the automated travel system and various resources interacting with the automated travel system;

FIG. 4 is a block diagram illustrating data interaction of a user's calendar with a travel client application and/or the automated travel system;

FIG. 5 illustrates a data flow for updating a traveler profile;

FIG. 6 illustrates various input data to a queue;

FIG. 7 is a now diagram for handling an emergency request;

FIG. 8 illustrates a data flow for group travel;

FIG. 9 illustrates a pre-trip form;

FIG. 10 illustrates a summary report form for business and personal charges; and

FIG. 11 illustrates an interface for requesting travel arrangements for a particular event.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ various computers, communication devices and media, interfaces, mobile and immobile devices, and servers which may carry out a variety of functions. In addition, the present invention may be practiced in conjunction with any number of travel and/or scheduling applications, and the system described is merely one exemplary application for the invention. Further, the present invention may employ any number of conventional techniques for data parsing and processing, communications among the various elements, presenting and exchanging data and commands, and the like.

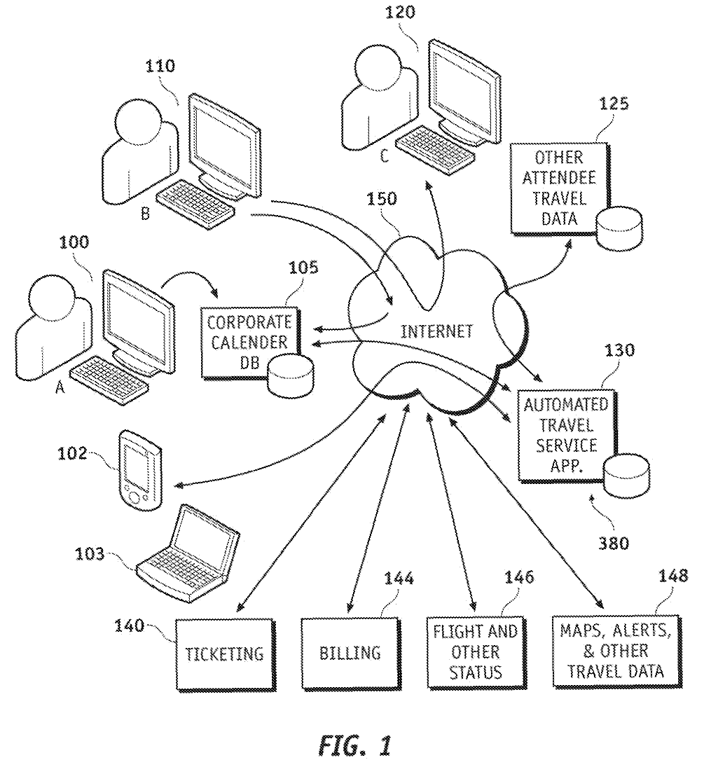

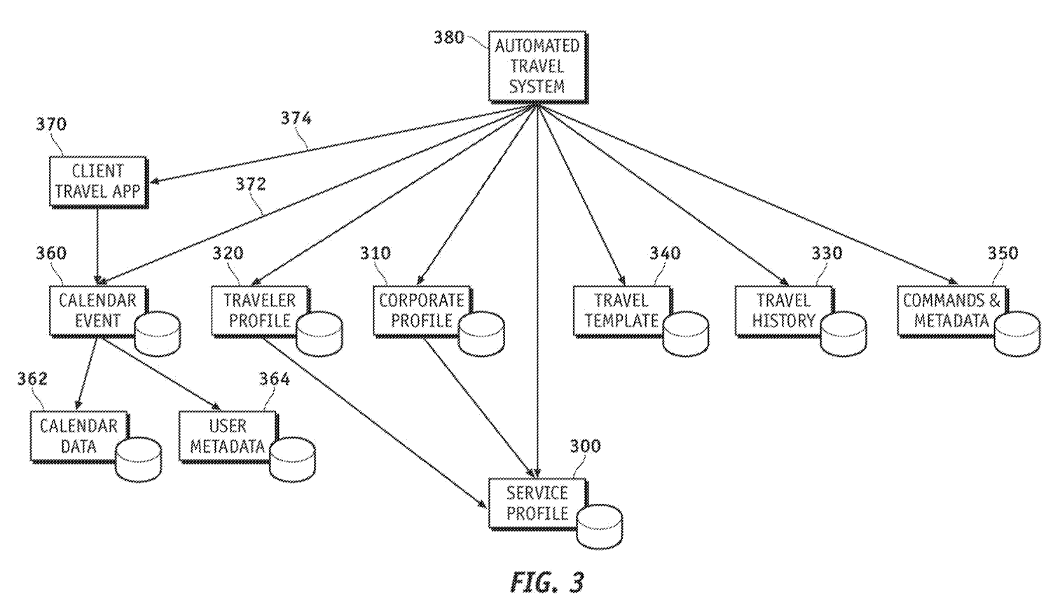

Various representative implementations of the present invention may be applied to systems for automated travel. Referring now to FIGS. 1 and 3, methods and apparatus for automated travel according to various aspects of the present invention may operate in conjunction with an automated travel system (ATS) 380 including an ATS application 130 operating on a computer. The ATS 380 may be accessible to one or more individuals 100, 110, 120, such as via the Internet and various devices adapted to communicate with the ATS 380.

The ATS 380 may connect to other services and data sources, including but not limited to data sources and devices for users 100, 110, 120, 125, ticketing systems 140, billing and credit card payment systems 144, and flight information and/or reservation systems 146. The ATS 380 may also communicate with other travel-related systems 148 that may provide information useful to the traveler and/or the ATS application 130, such as via web services, data requests or feeds, and/or web-enabled links. Such resources may include, for example, travel maps, regional maps, maps for segments of the trip including but not limited to travel routes from the airport to the venue or hotel, airport terminal maps, local attractions including shows, dining venues, concerts and sporting events, restaurants, road closures, and other travel information like national security terrorist alerts, international travel alerts, and similar data.

Each of the individuals 100, 110, 120 may be associated with one or more devices, accounts, and/or systems that may interact with the ATS 380. For example, a first traveler A 100 may be associated with one or more mobile devices, such as a handheld device 102 or laptop computer 103, that may interact with the ATS application 130 via the Internet or other packet network. The first traveler A may also be associated with one or more computer accounts on one or more computer networks, such as a business network operating in conjunction with a database 105. The database 105 may store any suitable information, such as calendar data, billing data, and/or contact information. Other individuals, such as traveler B 110 and traveler C 120, may be likewise associated with one or more devices, accounts, and/or systems.

In the present embodiment, one or more individuals 100, 110, 120 may have one or more handheld devices 102, such as cellular telephones, personal digital assistants, or personal media players adapted to directly or indirectly communicate with the ATS 380. The individuals 100, 110, 120 may also or alternatively have one or more computing devices, such as a laptop computer 103. In one embodiment, such devices 102, 103 may comprise wireless components adapted to communicate via broadband or modem access over the public switch telephone network (PSTN). The users' devices 102, 103 may connect to the Internet and to the Internet-enabled ATS application 130 via voice or data connection, such as but not limited to cellular, cellular data (such as Evolution-Data Optimized or EV-DO, UMTS/HSDPA), WIFI, or WiMax. In the present embodiment, the devices 102, 103 may support voice or data access to the traveler's itinerary or other travel information. Such information may be stored locally on the device itself or remotely, such as on the ATS 380. Localized information stores may be synchronized with system data stores periodically, such as via a network or direct connection. The devices 102, 103 may also communicate with the ATS application 130, for example via commands and data embedded in chat, SMS, or similar messages.

The devices associated with the individuals 100, 110, 120 may operate in conjunction with a scheduling application, such as conventional calendaring and/or appointment applications like Microsoft Outlook or Google Calendar. In one embodiment, the scheduling application may include an invitation function to invite other individuals to an appointment, such as a meeting at a particular location. The devices 102, 103 may communicate and synchronize data through the Internet or other packet network, such as via a corporate mail and calendar application, and/or communicate directly with the ATS 380, such as via the Internet or other appropriate communication medium. The various devices, accounts, and systems of a particular user may synchronize with each other, as well as the database 105 or other system, such as via a back office server operating Microsoft Exchange Server or a web-enabled server.

For example, traveler B 110 may electronically invite traveler A 100 to an appointment via the scheduling application, such as using the INVITE ATTENDEES functions associated with Microsoft Outlook's calendar functions. The invited traveler A 100 can electronically accept the invitation from the meeting inviter traveler B 110. Each calendaring application notes the particulars of the appointment, such as time, location, subject matter, and other participants. The information on the appointment is synchronized to all of the relevant devices, accounts, and systems, such as using conventional synchronization processes.

The ATS application 130 receives data from the scheduling applications for one or more individuals 100, 110, 120 and automatically makes travel arrangements accordingly. Travelers often have the information pertaining to the location, date and time of appointment they wish to attend already entered into their scheduling applications. The ATS application 130 facilitates automatically accessing that information and generating appropriate arrangements. In addition, the ATS application 130 may be adapted to manage arrangements, such as identifying that a connecting flight has been cancelled and automatically rescheduling an alternate flight on the same or another carrier so that the traveler may continue the trip without unnecessary delays. The ATS application 130 may automatically make changes to the user's schedule without the traveler's acknowledgement, including but not limited to automatically creating, changing, and cancelling various transportation, such as airline reservations and car rental reservations. The ATS application 130 may make and control such arrangements according to the traveler's preferences, as well as within the bounds of corporate or personal travel guidelines.

The ATS application 130 may be adapted to automatically add or delete legs of a trip, make or change hotel reservations, and make, change or cancel various appointments such as sporting events, theaters, dinner reservations, and other such entertainment or concierge services without any involvement of the traveler. The ATS application 130 may also notify the traveler of changes, such as via common communication mechanisms like email, SMS, IVR and Automatic Speech Recognition (ASR), and/or Text To Speech (TTS). Further, the ATS application 130 may not only update the traveler's scheduling application data, but use historical information from past scheduled events to define both current and future travel. The ATS application 130 may also coordinate such operations for multiple individuals, for example according to the users' travel history, travelers concurrently traveling with the user, business-related travel restrictions, and the preferences of the various travelers.

In one embodiment, the user may simply enter a desired location or appointment into the user's scheduling application and allow the ATS application 130 to automatically make all travel reservations including hotel, car, air and event tickets/reservations, if applicable, without the user having to make the individual selections. The ATS application 130 may also reschedule travel arrangements automatically if it detects flights or other travel has been canceled, delayed, or otherwise altered, providing convenience and time savings.

The ATS application 130 may operate on a computer system, such as one or more servers or server farms. The functions of the ATS application 130 may be performed by a single machine or may be distributed among several machines, including the user's machine. In the present embodiment, the ATS application 130 operates on a remotely accessible travel server adapted to communicate with other systems, such as the user's devices 102, 103 and one or more other remote systems 125, 140, 144, 146, 148.

The ATS application 130 may receive data from the traveler before, during, and after the start time of the trip, meeting, or other appointment. The data may be entered into the traveler's scheduling application, entered into a client travel application interacting with the traveler's scheduling application, or communicated directly to the ATS 380 via any suitable technique, including but not limited to SMS, email or ASR. For example, the ATS application 130 may directly or indirectly access the data 362 for one or more users' scheduling applications. The ATS application 130 may monitor or otherwise receive data from the scheduling application, such as via intermittent polling of a calendar database, notices from the scheduling application or a client travel application operating on the user's device. In addition, the ATS application 130 may receive data provided via alternate channels, such as via metadata/commands 350, 364 which may come from one or more sources.

In one embodiment, the ATS 380 may be adapted to receive data from various sources. For example, if the client computer is on a corporate network supporting a shared calendar arrangement, a copy of the user's calendar may be accessible to the ATS 380 via direct access (372). Another user's calendar 360, however, may reside on a client computer and may not be directly accessible by the ATS 380.

To allow access to this data, the ATS 380 may operate in conjunction with a client travel application 370. In one embodiment, the scheduling application may be adapted to communicate automatically with the ATS application 130 to share relevant data. Alternatively, the client travel application 370 may access the relevant data from the scheduling application database and provide it to the ATS application 130. The client travel application 370 may communicate with the automated travel system 380 (374), such as via a web service on the ATS 380, remote procedure calls, conventional dedicated client/server architecture, or other appropriate communication technique. The client travel application 370 and/or the scheduling application may update the ATS 380 with changes to the user's calendar data 362 as they occur or on a periodic basis. The client travel application 370 may be implemented in any appropriate manner, such as via an application operating on the user's device or a back office server, for example a server running Microsoft Exchange.

Relevant data may be provided to the ATS 380 from sources other than the scheduling application. For example, to guide the ATS 380 for such appointments, the user may provide additional data before or during a trip. In one embodiment, the user may provide information via text-based metadata and/or metacommands, for example via text insertions in the scheduling application, SMS, or text messaging input to the travel system. For example, the ATS 380 may receive a metadata command text such as “//On Snow Delay Cancel Minneapolis Leg” embedded into a traveler's calendar. If the ATS 380 determines that the relevant Minneapolis leg has indeed been delayed due to snow, the ATS 380 may automatically cancel the trip accordingly.

In the present embodiment, the ATS application 130 may receive and operate upon multiple metadata commands/keywords or other text-based messages to allow the traveler to provide input to the ATS 380. Metadata commands/keywords can also be used to query the travel application regarding data pertaining to the trip destination and pertaining to other business travelers attending the same location. To simplify the use of the metadata and to make it more like natural language rather than programming constructs, words may be considered logically true unless they have the word “No” or “Not” before them. Thus, “//fly Monday” infers travel on Monday while “//no fly Sunday” indicates that the ATS application 130 system should not book travel on Sunday. Furthermore, metadata may be placed in any order within the user's calendar entry. If, for instance, a meeting is scheduled, but the person invited wishes for the ATS 380 not to automatically schedule the trip for them, they may simply enter “//no trip” anywhere in the meeting invite text.

The ATS 380 may also interpret input data, such as to facilitate convenient input via the scheduling application interface. Busy travelers may not take the time to enter complete meta sequences. The ATS 380 may interpret all words behind any meta tag delimiter according to any appropriate criteria. Thus, if the ATS 380 receives “//business class”, it may attempt to interpret the input as “//fly business class”.

After interpreting the meta command, the ATS 380 may respond with confirmation to the traveler to inform the traveler that the metadata command has been received and interpreted. For example, the ATS application 130 may enter data into the scheduling application with text. Thus, if the ATS application 130 receives a “//no trip” command, the ATS application 130 may insert the word “confirmed” back into the user's calendar. Thus, “//no trip {confirmed}” would appear on the user's interface. If actions are requested such as “//fly business class”, then “//fly business class” would be printed as a summary at the bottom of any itinerary generated.

The number and types of metadata can be adjusted to accommodate aspects and features of the ATS 380. The meta command feature may also be extended to input via a multimodal interface. For example, the metadata may be entered via SMS in real time or to define information that can be acquired via other means. As an example, a user may enter “//flight status, hotel status, and weather (audio)” as an SMS input to the ATS 380. When the user calls a predetermined number which connects to the ATS 380, the flight status, hotel status, and weather may be provided to the caller aurally and automatically, foregoing the need for IVR or ASR. Alternatively, the ATS 380 may automatically call the user in response to the request and use speech recognition to play back the specified information.

The data received by the ATS 380 may be provided by any appropriate resources and/or media. For example, referring to FIG. 6, the user's calendar data 605 may be parsed for information pertaining to the time and location of an appointment. The calendar may have additional metadata embedded inside the body of the calendar entry itself or may have metadata included in the text. Such metadata, as previously described, may include such input as “//No Sunday Flight”, which tells the ATS 380 not to book travel on a Sunday.

The calendar may be accessed by the client travel application 606, which may parse the calendar entry including the time, location and purpose or the appointment. The client travel application 606 may be implemented as a plug-in function of the calendar or a separate executable on the user's device, which can further accept data directly as well as further parse the data embedded in the calendar entry. The client travel application 606 may prompt the user for such input or allow the user to input such data in free form fashion.

The ATS 380 may also receive information via text-based communications, such as a SMS message, text message, instant message, or the like 607. For example, the message may use a form similar to that of metadata entered into the calendar. Thus, the user may send an SMS message to the system with recognizable keywords such as “No Sunday Flight.” Because the text message would be directed to the ATS 380, an initial delimiter indicating the transmission of metadata is not required. If such a delimiter is included, it may be discarded by the ATS 380. Thus, “//No Sunday Flight” would be accepted as well.

The user may also provide data to the ATS 380 via other communication systems, such as Interactive Voice Response (IVR) or Automatic Speech Recognition (ASR) systems 608. Thus, the user may use a touch tone phone or voice input to give direction to the ATS 380. The words and/or symbols typed as metadata into the calendar 605 may be spoken to the system 608 to effect similar actions.

The ATS 380 may also receive data via email containing data or commands, such as an email containing metadata commands embedded in the body and/or the subject line of an email 609. For example, the email may include the instructions “//Rental AVIS 3-3-2018” in the subject line. The ATS 380 may recognize the source of the request from the source of the email to associate the commands and/or data with the appropriate user. In addition, the ATS 380 may recognize or receive email at a predefined email address for particular functions. For example, the email address car@remotian.com may permit the sender to specify the location and the dates in the subject line or in the body of the message. Such predefined emails allow a user to easily make travel changes by simply sending an email.

The ATS 380 may allow interaction using multimodal forms 610, such as input comprising a combination of text, graphical and speech input. For example, multimodal forms may be generated using a combination of VoiceXML, Speech Application Language Tags (SALT), or similar technologies. The ATS 380 may also communicate in conjunction with web forms 611 by logging into the ATS 380 via an Internet-enabled computer.

In one embodiment, the ATS 380 may logically interpret metadata as part of a data parsing flow. Data to command the ATS 380 to take certain actions may come from multiple sources. The received data forms a queue 620 of input data from the traveler. The data may be associated with a time stamp, for example prior to being delivered to the ATS 380, as multiple sources of data can affect the actions of the ATS 380. If there is no time stamp on the data, then the ATS 380 may add a time stamp to the data upon receipt.

Because the input to the ATS 380 may be asynchronous with inputs coming from multiple sources 605-611 to the system queue 620, the ATS 380 may recognize the sequence of requests, such as using the time stamps or the order in which the data is received. A valid newer request may supersede an older request. For example, if a request for a rental car “//AVIS 4-20-2012” arrives at 13:14:00 and a request for “//National 4-20-2012” arrives at 13:25:00, the older request may be discarded, unless a specific directive to the contrary is included or some other criterion is applicable. Such a request may, for example, take the form “//+National 4-20-2012”, which may add the request to a previous request instead of replacing it. The “+” symbol is exemplary; any appropriate keywords or symbology may be used to effect different communications and actions.

The queue 620 forms an ordered list. The queue 620 may facilitate tasks that are not processed as they are received. Some requests may be executed upon receipt, and others may be queued based on conditionals or pending other input to the system. For example, a macro-like command may be given to the ATS 380 which indicates that if certain conditions occur, the ATS 380 should take another step. Thus, the user may instruct the ATS 380 that if a meeting is extended, the ATS 380 should automatically rebook a flight at an appropriate time after the meeting is expected to end, or if a specific flight is delayed or if there are no other flights that day, book a hotel, etc. The queue 620 requests may be executed by the ATS 380 (630), and the ATS 380 may provide notifications to the user 100 via any suitable communication technique, such as SMS or email (640).

The ATS 380 may be further adapted to receive data from a proxy for the particular individual 100, 110, 120, such that the one or more proxies may act on behalf of the traveler. The proxy may be any appropriate individual, entity, or mechanism, such as a traveler's assistant or spouse. For example, the ATS 380 may be adapted to permit a traveler's wife to take selected actions, such as to obtain tickets to a favorite sporting event while the couple is traveling and have the event show up in her husband's calendar without any involvement from the husband. The traveler's scheduling application may be automatically updated via the ATS 380.

Upon receiving data and/or commands from the various possible sources and/or via the various communication media, the ATS application 380 may organize the data to make the travel arrangements. For example, the ATS application 130 may parse the received data to identify the tasks to be performed. In addition, referring again to FIG. 3, the ATS application 130 may retrieve additional information that may affect the travel arrangements, such as a service profile 300 identifying potential suppliers of services and goods, a traveler profile 320 containing information relating the traveler and preferences, and/or a corporate profile 310 containing information regarding the travel information, preferences, and/or restrictions of an associated company. In addition, the ATS application 130 may coordinate the travel arrangements among multiple travelers, such as travelers traveling together, attending the same appointment, or otherwise related.

In the present embodiment, the ATS application 130 processes the incoming data to identify the arrangements to be made. For example, the ATS application 130 may receive data relating to a particular meeting or other appointment from the scheduling application and/or the client travel application 370 for the first user A 100 and parse the incoming data to establish the relevant date and location. The ATS application 130 may also analyze the incoming data for other relevant information, such as the duration of the meeting, whether recurring meetings are scheduled, and the like.

Referring again to FIG. 3, as an example, the user may receive and accept a calendar invitation via the user's scheduling application for a meeting in a remote city in one week. The calendar entry data 362 indicates the time and location of the meeting, such as in the location line of the meeting invitation or in the body of meeting invitation. The user may, however, have a unique request for the system and may choose to embed one or more directives, such as in the form of user metadata 364, to the ATS application 130 within the body of the meeting invitation. An example might be “//No Travel Sunday”. The user metadata 364 may be embedded in the calendar event 360 and automatically parsed by the client travel application 370. The travel client application 370 may determine whether the metadata is valid and, if so, communicate the relevant directive, along with other information pertaining to the time and location of the trip, to the ATS application 130 residing on a remote server to proceed with making the travel arrangements.

The user may later send a command or other data 350 to the ATS application 130. Such commands may be sent directly to the ATS application 130, such as via an SMS text message from a handheld mobile device. The text commands embedded in the SMS message may utilize similar or identical key words as those embedded in the meeting invitation or those text commands that may be inputted directly to the ATS application 130, such as via a form. For instance, the user may send an SMS message “//No Travel Sunday” to the ATS 380 to prevent the ATS application 130 from scheduling travel on Sunday.

Upon receipt of data for a new meeting, the ATS application 130 may analyze the data to determine whether any arrangements may be required. For example, depending on the location, nature, and participants of the meeting, travel may or may not be required. The ATS application 130 may apply any appropriate criteria to determine whether travel arrangements are required, such as the location of the meeting, the anticipated location of the relevant individual, potential conflicts, and the nature of the meeting (for example, a teleconference would not require travel arrangements). The analysis may be performed by any appropriate element or system, such as the ATS application 130, the client travel application 370, the scheduling application, or the user via a prompt or other appropriate mechanism.

The ATS application 130 may identify relevant information relating to the travel arrangements. For example, the ATS application 130 may acquire location and time information for the meeting and the user's anticipated location at the time of the meeting from a meeting request, a calendar entry, the scheduling application, a corporate database, or other suitable resource. The ATS application 130 may also gather other travel parameters from other resources, such as information relating to the traveler, company requirements or preferences, and/or information for other related travelers.

For example, referring again to FIG. 3, the ATS 380 may access a traveler profile 320 for the relevant individual. The traveler profile 320 may comprise any relevant information relating to the traveler, such as but not limited to name, hotel preferences, seating preference in airplanes, airline preference, frequent flyer numbers, billing information, emergency travel contact information, personal, business, cellular phone numbers, text or SMS contact information, time of travel preferences, medical history information pertaining to any conditions they may be stricken with while traveling, passport information, any special needs they may have if they are handicapped or disabled in any fashion, email contact, names and contacts of individuals to contact if there are delays in the trip, drivers license information, citizenship information including any work permits, photos and physical description to assist in locating the traveler if for some reason they would become lost during the travel, and any other information specific to the user or the type of travel or business nature that they are traveling for and/or that may be useful in arranging travel for the individual. It may also contain the names and IDs of individuals that can make or change travel arrangements for them. In various embodiments operating in conjunction with calendar entries, any personnel enabled to make calendar changes for the traveler may be automatically qualified to make or modify travel for the traveler.

The traveler profile 320 may be generated in any suitable manner, such as via data entry by the user and/or analysis of the traveler's scheduling data and/or travel history. For example, when a traveler first connects to the ATS system 380, the ATS system 380 may set up an account for the traveler and request initial information to generate the traveler profile 320. In one embodiment, the ATS system 380 presents the traveler with a number of questions and/or forms adapted to gather information pertaining to the traveler's travel preferences, such as via web-based forms or locally via the client travel application.

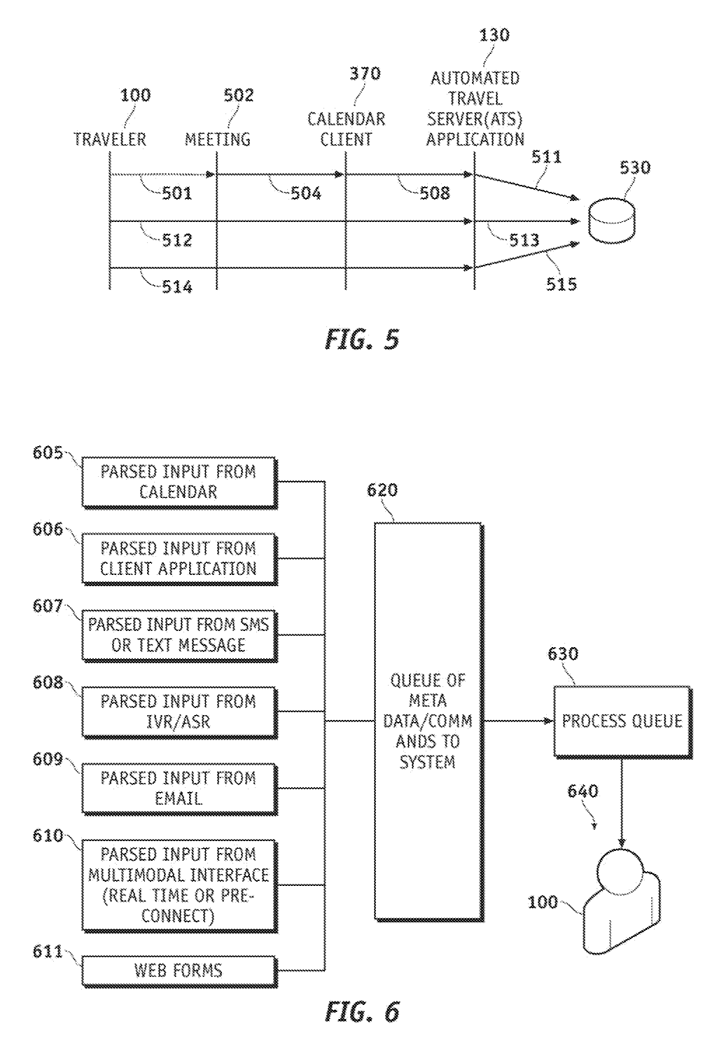

The traveler profile 320 may be updated automatically or manually. Referring to FIG. 5, the traveler profile 320 may be stored in a database 530, such as a database of the ATS 380, and the traveler 100 may input or edit the traveler's profile 320 via the ATS application 130. In the present embodiment, the traveler 100 may update the traveler profile 320 by logging into the ATS application 130 and updating the data, such as in conjunction with a web form (512). The results are written to the travel profile 320 (513).

The traveler may also send a metadata command via electronic messages, such as via a text or SMS message (514), to the ATS 380, which is then written to the travel profile 320 (515). The metadata describing the desired updates may be embedded in the message and sent to an account associated with the ATS application 130, such as an email address to text message number. The update data may also be submitted via other communication techniques, such as IVR, ASR or other multimodal interfaces.

In addition, the traveler 500 may update the traveler profile 320 by writing metadata into a meeting invitation 502 (501). For example, the data may be written into the body of the meeting invitation 502, into any header fields of the meeting invitation 502 such as the location field, or it may be written as viewable text or as hidden text within the body of the meeting invitation 502. The user may also write data directly to the client travel application 370, such as submitting metadata via a graphical user interface and one or more forms for entering data. The meeting data may be parsed and verified for validity (504). The traveler 100 may be prompted for changes if the metadata is invalid, for example by the client travel application 370, the ATS application 130, and/or the scheduling application. If the data entered is determined to be valid, it may be processed by the ATS application 130, which updates the travel profile 320 by writing the updates to the database 530 (511).

For example, the traveler may enter text into the body of the meeting invitation 502, such as “//profile update rental AVIS”, which would be parsed by the client travel application 370, sent to the ATS application 130, and written into the travel profile 320. In this example, the text indicates that the traveler profile 320 is to be updated and the rental default is to be set to AVIS. Such metadata may be used for controlling the travel arrangements, updating the traveler profile 320, and facilitating automatic trip approval, as well as tracking charges directly or indirectly associated with the trip or the client/customer visited during the trip with which charges may be associated.

The ATS 380 may also utilize the traveler's travel history to prepare the travel arrangements. For example, the ATS 380 may use the information to project future travel arrangements which may not have been specified via the scheduling application, such as to select or refuse previously selected hotels, flights, travel times, and the like. Referring again to FIG. 3, in the present embodiment, the travel history 330 is stored in a location accessible to the ATS application 130. The travel history 330 may include any suitable information, such as data relating to previous trips to specific locations and what accommodations were used for that travel.

The travel history 330 may be acquired in any suitable manner, such as from previous trip information arranged via the ATS 380 and previous scheduling application information. In one embodiment, when a traveler first registers for the ATS 380, the client travel application 370 may scan a person's previous travel, such as via the scheduling application. If the client travel application 370 finds trips or periodic meetings/trips, the client travel application 370 may record the travel locations and/or prompt the traveler as to what the traveler liked or did not like about the various trips. If the trips appear to be periodic, the client travel application 370 may also enter such trips into the scheduling application and/or the ATS application 130 for future travel. The ATS application 130 may also otherwise process the travel history data to identify travel arrangements the traveler selected for previous trips. As new travel is arranged and completed, the travel history 330 may be updated, such as automatically by the ATS application 130.

The ATS 380 may automatically utilize the travel history 330 to make travel arrangements for new trips. For example, the traveler may have stayed in a certain hotel on a prior trip to Chicago called “Cheapest-Hotel-In-Chicago”. If the traveler has another meeting in Chicago entered in their calendar, the ATS application 130 may attempt to schedule the trip based on historical information, such as by reserving a room at the same “Cheapest-Hotel-In-Chicago” hotel.

If the traveler did not like the hotel accommodations at “Cheapest-Hotel-In-Chicago”, the traveler may update the travel history 330 to ensure that the hotel is not selected for future trips. The traveler may also wish to specify one or more particular hotels for future trips to Chicago in the traveler profile 320. For example, the traveler may provide metadata to modify the travel arrangements, such as in conjunction with conditionals and logical operators like the word NOT. The metadata may be provided in any appropriate manner, such as entering the data via the scheduling application or a graphical user interface window associated with the client travel application 370.

In the present embodiment, the traveler 100 may add text for a calendar entry or otherwise provide metadata indicating that the ATS 380 should take different action. For example, the traveler 100 may enter “//Hotel Airport Hilton” in the meeting entry in the scheduling application. The ATS application 130 may attempt to schedule the traveler into the Hilton hotel closest to the traveler's destination airport. The traveler may alternatively enter “//Hotel NOT ‘Cheapest-Hotel-In-Chicago’” or “Hotel NOT (last trip)” and the ATS application 130 may find another hotel other than the “Cheapest-Hotel-In-Chicago” based on the traveler profile 320 and/or any other relevant criteria.

The ATS 380 may also access other relevant data for making the travel arrangements, such as a corporate profile 310. The corporate profile 310 may comprise travel preferences, requirements, and/or restrictions for travelers associated with a company or other person or entity, such as employees, contractors, representatives, and the like. For example, the corporate profile 310 may define a subset of available services and vendors from which the traveler may choose, thus permitting the company to control the travel arrangements of travelers associated with the company. An authorized person for the corporation may create the corporate profile 310, for example by enabling or disabling a set of possible options from a list of providers or other options. For example, the company may enable booking car rentals with one or more agencies with which special rates have been arranged, and disallowing other options. The corporate profile 310 may further include different options for different types of travelers, for example providing better travel options for senior personnel and more limited options for junior personnel. As part of the corporate profile 310, a person authorized to control the names and relationships of approvals for travel may update the corporate profile 310 to allow for automatic routing of travel for such approval.

For example, the company may have contracts with particular car rental agencies, such as AVIS and National, so the corporate profile 310 may include parameters restricting travelers to renting from the two permitted agencies. The corporate profile 310 data may be provided to the traveler, for example via scheduling application menus or metadata, to facilitate the traveler's selection.

The ATS 380 may also facilitate coordinating travel for groups of people. In one embodiment, the ATS 380 may coordinate travel for multiple people, such as to reach the same destination, attend the same meeting or event, travel together, stay in the same lodgings, share transportation, or the like. Two or more people may need to travel for an event, such as a trade show or annual meeting. The travel may require many travel requests, and those traveling may be directed to all stay at one location or a small group of hotels. In addition, the travelers may require concurrent travel on a small set of available airlines, and they may need one or more vehicles for transportation.

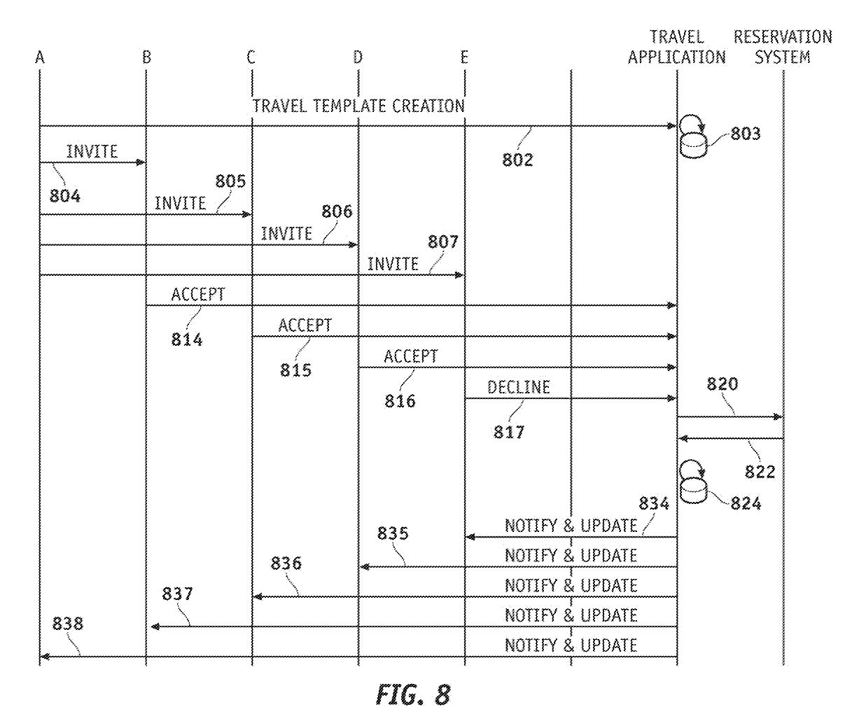

The ATS 380 may coordinate travel in any appropriate manner, such as by arranging travel for all of the invited attendees that have accepted the invitation. The ATS 380 may coordinate arrangements so that everyone traveling on a trip has similar preapproved travel arrangements. For example, to facilitate coordination of travel arrangements, a travel template can be created by a trip organizer, and the travel template may be referenced in the meeting invite. In the present embodiment, referring to FIG. 8, the trip organizer A creates a travel template for that travel (802) so that the various personnel are not required to enter specific information, such as flight, hotel, or car.

The travel template may comprise any suitable information, such as travel dates, hotel accommodations, car rental, registration information for venues attended during the trip, and the like. The travel template may be required to comply with various requirements, such as the requirements or the corporate profile 310. The travel template may have a unique name be stored in a location accessible to the ATS 380, such as on an ATS database 803. An exemplary template may be designated “Chicago.12.15.2012”. When the organizer A invites travelers B, C, D, E to the meeting 804, 805, 806, 807, the invite may include a reference to the template, such as via metadata embedded in the meeting invite fields. For example, the invite may include the text “//Chicago.12.15.2012” embedded in the meeting title, location, and/or in the body of the meeting itself.

When the invited travelers receive and/or respond to the meeting invite, the meeting invite may be parsed to determine that the travel arrangements should be based on the template “Chicago.12.15.2012”. For example, the invite may be parsed by the ATS application 130, the client travel application 370, the scheduling application, or other appropriate system. In the present embodiment, the client travel application 370 parses the meeting invite and responds with an acceptance or rejection to travel (814, 815, 816, 817). The details of the travel template may then be accessed from the database 803.

In various embodiments, the invited individual may be permitted to override or adjust the travel template for the invited traveler's travel arrangements. For example, the invited individual may optionally embed metadata in the meeting invite response, or enter data into a form on the client travel application 370 to override one or more items from the travel template or add items specific to the individual traveler for the trip. The invited individual may also make changes only if authorized, such as according to the corporate profile 310 or a corporate travel template. For example, an authorized invited individual may specify “//hotel Hilton” rather than the template default “Motel 6” in the original invite.

Further, the invite may be analyzed in conjunction with the invited individual's schedule to coordinate the travel. For example, the template may show everyone flying from Phoenix to Chicago on 12-14-2012. However, traveler B 110 is in St. Louis on 12-14-2012. The client travel application 370 or other suitable system may embed data in the response to the invite so that traveler B 110 flies from St. Louis to Chicago on 12-14-2012 instead of from Phoenix.

The ATS system 380 may make travel arrangements according to the data received from the scheduling application and any other relevant criteria. The ATS system 380 may make the travel arrangements in any suitable manner, such as in conjunction with automated reservation systems for transportation, accommodations, event admissions, and the like. The ATS 380 may also offer default travel arrangements, offer options to the traveler for acceptance, rejection, modification, and/or updating, and provide itineraries and other information to the traveler.

The ATS 380 may use the relevant trip criteria and data to research travel options and/or select initial travel arrangements. For example, the ATS application 130 may identify the traveler's origin, destination, and travel date to determine to identify and research travel options. Referring again to FIG. 3, in the present embodiment, the ATS application 130 selects the travel options according to a service provider profile 300. The service provider profile 300 includes information relating to providers of services and goods to facilitate making the travel arrangements, such as contact information for automatic reservations systems for airlines, car rental companies, hotels, event tickets, and the like. The ATS application 130 may use the data in the service provider profile 300 to populate travel options. The ATS application 130 may then present the travel options to the traveler, organizer, or other user. The service provider profile 300 data may be provided to the user at any time, such as before the meeting data is entered, following entry of the meeting data, or after initial travel arrangements have been researched.

The service provider profile 300 may include any appropriate information regarding the service providers. Generally, the service provider profile 300 may define the services and vendors available to the traveler via the ATS 380. The service provider profile 300 may also include payment information, such as facilities to pay for services using American Express and Visa. The service provider profile 300 may be dynamically adjusted and may include all resources that can be scheduled directly. In one embodiment, the service provider profile 300 contains a complete list of hotels, airlines, car rental, and similar resources that can be scheduled or reserved via the ATS 380. In the present embodiment, the data is stored as XML data, but may be stored in any format to be read and interpreted by other applications accessing the service provider profile 300.

As an illustrative example, the service provider profile 300 may support booking through rental car companies. The service provider profile 300 may include data for arranging car rentals through AVIS, National, Hertz, and Budget. Thus, the ATS 380 may be capable of arranging car rentals through all of these companies, but not Alamo. When Alamo is added to the service provider profile 300, then car rental arrangements may be made with Alamo via the ATS 380. Access to the various providers in the service provider profile 300 may be limited, however, by other criteria. For example, the corporate profile 310 may limit travelers associated with the company to using AVIS and Hertz. In such a case, the ATS 380 would not make car rental arrangements for the traveler using National, Budget, or Alamo. As another example, the traveler profile 320 may indicate that the traveler prefers National and dislikes Budget. The ATS 380 may then attempt to arrange the car rental through National and/or omit Budget as a travel option.

Upon identifying acceptable service providers, the ATS 380 may provide the relevant trip data to the selected service providers to identify possible travel arrangements. The ATS 380 may modify and/or supplement the trip data from the scheduling application and/or the client travel application 370 and select the service providers according to any appropriate criteria, such as according to the traveler preference indicated in the traveler profile 320, limitations or preferences in the corporate profile 310, parameters identified in the travel template 340, information stored in the travel history 330, and/or commands 350 received from the traveler or other source.

For example, the scheduling application may indicate that the traveler needs to be in Chicago for a noon meeting on Wednesday, and that the traveler will be finishing another meeting in San Francisco on Tuesday in the late afternoon. The traveler profile 320 may indicate that the traveler prefers traveling the day before a meeting if possible, so the ATS application 130 may initially explore travel options for Tuesday afternoon and evening before travel options on Wednesday morning. In addition, the corporate profile 310 may indicate that the traveler is permitted to fly first class if the flight is likely to exceed two hours, so the ATS application 130 may research the availability of first class flight tickets. The travel history 330 for the traveler may suggest that the traveler prefers nonstop flights, so the ATS application 130 may give preference to nonstop flight options.

In response to the trip data provided by the ATS application 130, the service providers may return various travel options. For example, the ATS application 130 may receive information for various flights from different service providers that fly from San Francisco to Chicago in the late afternoon or evening of Tuesday. The ATS application 130 may also research additional options for Wednesday morning, for example according to the number of options available on Tuesday or a selected number of options desired by the traveler. The ATS application 130 may acquire information on any suitable number and type of options, such as different airlines or possible alternatives, such as trains, car rentals, or private jets. In addition, the ATS application 130 may request information on other aspects of the trip, such as accommodations, car rentals, taxis or limousines, and the like.

The ATS 380 may forward the data to the traveler or other system for further analysis, or may process the data, such as to identify preferred options for the traveler and/or to avoid conflicts. For example, the ATS application 130 may have access to, or receive from the scheduling application or the client travel application 370, other information in the traveler's scheduling application, such as information relating to other appointments. The ATS application 130 may process travel options according to the other obligations on the traveler's calendar to avoid and/or provide notice of conflicts.

For example, the scheduling application may indicate that the traveler has a meeting the day following a scheduled trip. The ATS application 130 may attempt to schedule travel so as to avoid conflict. If conflict cannot be avoided, then the ATS application 130 may send a notice to the traveler, such as via the scheduling application, relating to the conflict and allow the traveler to decide whether to cancel a meeting or trip, reschedule, or otherwise resolve the conflict. If the traveler is scheduled to participate in a teleconference from a remote location, the ATS application 130 may avoid booking travel that would interfere with the teleconference. The ATS application 130 may avoid any bookings just prior to, during and just after the teleconference, thus giving the traveler time to get to an appropriate location, participate in the meeting and then get to the next travel-related event. The ATS application 130 may utilize maps, geocoding, distances, and the like to calculate the appropriate time buffers prior to and after the scheduled event, such as the teleconference.

The ATS 380 may forward the travel information to the traveler for acceptance, rejection, or modification. For example, the ATS application 130 may forward information for selected travel arrangements to the traveler's scheduling application to be inserted into the traveler's calendar. The traveler may also be sent an alert and an opportunity to accept or reject the travel arrangements, such as via selection buttons. Alternatively, the ATS application 130 may send various travel options to the traveler, such as via email, text message, the scheduling application or client travel application 370, and invite the traveler to view the travel options and select the desired options or adjust the search parameters for alternative travel options. A confirmation and itinerary may be automatically and conveniently written into the traveler's calendar, and hard and soft copies of the itinerary may be forwarded to the traveler, such as according to the corporate profile 310 or by the traveler profile 320.

In the present embodiment, referring again to FIG. 8, the ATS application 130 completes the reservations (820) with a response/confirmation from the reservation system (822). The confirmed reservations/bookings along with a copy of a complete trip itinerary may be written to an ATS 380 database 824. If operating in conjunction with a group of travelers, each invited participant may be notified with the trip information (834, 835, 836, 837). The organizer may also be notified (838). The ATS application 130 may provide the notifications via any appropriate mechanism, such as according to a preference selected by each traveler and designated in the traveler profile 320.

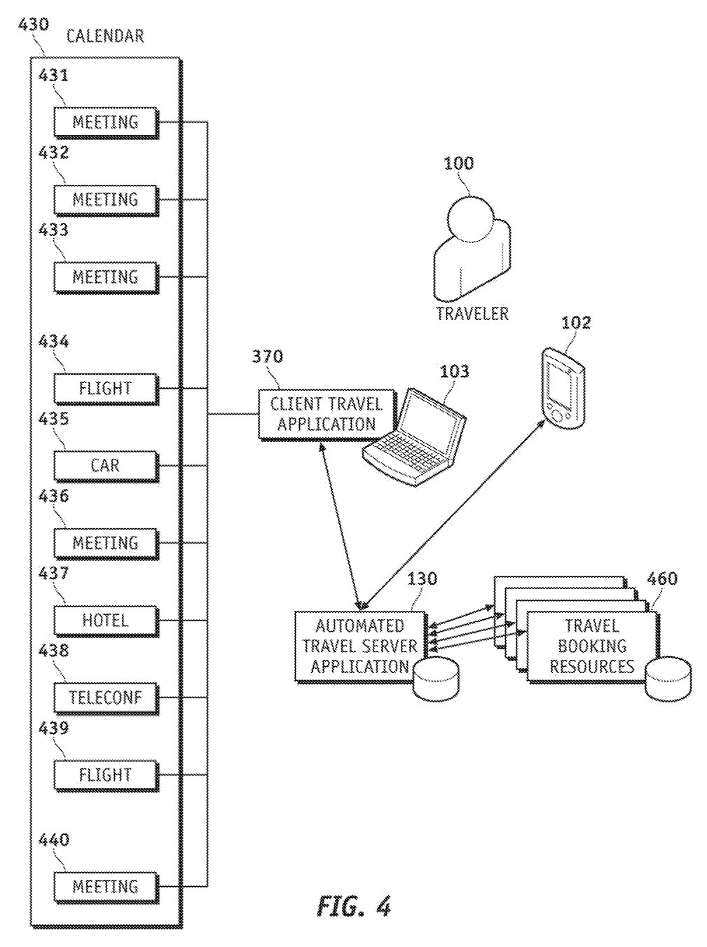

Thus, the ATS 380 may communicate with several other systems to automatically make travel arrangements according to information in the scheduling application and various other criteria. As an example of the process, referring to FIG. 4, the ATS application 130 on a hosted server is accessible via a packet network, such as the Internet. The ATS application 130 has access to a database and is also connected to various resources for booking travel with airlines, hotels, car rental companies, cruise lines, etc. The ATS application 130 may also connect to the Internet for accessing web sites, for example to acquire maps, tickets to various venues, and general information of interest to the traveler.

The traveler 100 has a personal computer 103 running the client travel application 370 integrated with the scheduling application, such as a calendar 430, on the computer 103 or is capable of reading and writing to the calendar 430 that the traveler 100 uses on the computer 103. The traveler 100 may also have one or more mobile devices 102 that can transmit and/or receive messages from the ATS application 130, such as via cellular, Wi-Fi, WiMax, or similar communication technologies. The communications enable the traveler 100 to connect to the ATS 380 directly to communicate travel preferences and to receive travel related updates.

The traveler 100 may receive a meeting invitation for a meeting, which the traveler 100 opens and accepts. Before closing the meeting, the traveler 100 may add additional information, such as metadata text, to the body of the meeting. For example, the traveler 100 may enter “//Book Travel” into the body of the calendar entry.

The client travel application 370 reads the metadata in the meeting body 436 that has the instruction to book travel for the meeting. The client travel application 370 may access other information in the traveler's calendar 430, such as to identify past, current and future meetings 431, 432, 433, 436, 440. The client travel application 370 may determine whether the calendar 430 includes information on a previous trip to this location by querying the ATS 380. If the traveler 100 has traveled to a corresponding meeting in the past, the client travel application 370 and/or the ATS 380 may use the information to automatically book the trip without any prompting of the traveler 100. For example, the ATS 380 may book travel according to the actual location of the meeting and previous selections for airlines and flights, accommodations, and ground transportation.

The client travel application 370 may also note that the traveler 100 has a teleconference scheduled 438. The ATS application 130 may attempt to schedule the return flight 439 after the teleconference 438 and allow sufficient time for the traveler 100 to get from the hotel to the airport after the teleconference. When the information has been gathered, the client travel application 370 may request for the trip to be booked. The ATS application 130 may access resources 460 and route the travel request to personnel for approval if it is a business-related trip.

Once the trip details and/or options are established, the information may be sent from the ATS application 130 to the client travel application 370, which may write the information into the travelers' calendar 430. In this example, the outbound flight 434, the rental car 435, the hotel 437, and the return flight 439 are all written into each traveler's calendar. The ATS application 130 may optionally send the traveler 100 a message indicating the booking of the travel, such as to the traveler's mobile device 102. Notifications may be selected according to preferences that the traveler 100 selected in the traveler profile 320.

After the travel arrangements have been made, changes may be needed to accommodate changing circumstances. For example, the traveler's plans may change, such as new commitments or changes to the scheduled meeting or other meetings, and require adjustments to the travel arrangements. In addition, the travel circumstances may change, such as due to delay or cancellation of a flight. The ATS 380 may accommodate changes automatically in response to changes, including changes initiated by the traveler, organizer, or other party, and/or caused by changes in the available travel options. If changes occur during the trip, the changes may be accommodated by the ATS 380, and updates may be sent directly to the traveler's scheduling application or to the client travel application 370, which in turn may update the traveler's calendar.

For example, the ATS 380 may receive a notification to change travel arrangements. The notification may be generated in any appropriate manner. For example, the traveler may wish to initiate a change in travel plans due to a change in other plans or a change of mind. In one embodiment, the ATS application 130 may respond to metadata to adjust the travel arrangements, such as metadata entered into the traveler's scheduling application to change travel arrangements. The traveler may adjust the scheduling application for any appropriate reason and in any appropriate manner, such as to add a critical meeting which may cause a previously booked trip to be scheduled differently, including but not limited to being delayed, shortened, lengthen, or even cancelled. In addition, the change to the travel plans can tie the trip to other travelers, travel approval, hotel or other lodging arrangements, and in general, any required and schedulable resource which may be associated with a scheduling event.

The traveler may also make changes to the traveler profile 320 or to communicate with the ATS application 130. For example, the traveler may schedule a trip to Chicago on the 15^{th} of April. In their last trip, the traveler stayed in the Hyatt Hotel at the airport. On this trip, the traveler would prefer to stay at the Hilton. To specify the change, the traveler may enter the information in a preference in the scheduling application or client travel application 370, edit the traveler profile 320 and specify the Hilton for Chicago trips, enter text representing the request into the calendar or other scheduling application (such as “//Chicago Trip //Hilton”), send an SMS text message to the system (such as “//Chicago Trip //Hilton”), or use other interfaces to the ATS application 130 such as interactive voice response (IVR) or automatic speech recognition (ASR). In addition, the traveler may use web clients, such as on a computer or cellular telephone. The information may also come from any number of individuals acting as a proxy for the traveler.

Further, the event causing a change in the travel arrangements may be non-traveler data, such as a delay or cancellation of a flight. For example, the ATS application 130 may monitor the availability of booked travel arrangements to ensure that the arrangements remain available as booked. In the event that the arrangements are changed by a third party, such as a delay or cancellation, the ATS application 130 may automatically check the scheduling application for the traveler and determine whether to change the arrangements. For example, if a delay is short and unlikely to interfere with a connecting flight or another event or meeting, it may be acceptable and the ATS application 130 may maintain the original booked arrangement. If the delay is unacceptable or otherwise likely to require additional or different travel arrangements, the ATS application 130 may automatically make new travel arrangements.

For example, if a flight is canceled, the ATS application 130 may research and book another flight automatically and send one or more notices to the traveler, such as via text message and an update of the scheduling application. If there are no other acceptable flights until the next day, the ATS application 130 may book a flight for the next day as well as a hotel room and transportation to and from the hotel. The traveler may be notified of the change, but approval of the change may not be required. Consequently, the traveler may be informed of the situation and the change in travel plans upon accessing messages and/or the scheduling application.

Thus, a traveler may manage travel through the scheduling application, and the ATS 380 may autonomously adjust travel arrangements in response to requests from the traveler or other authorized parties and/or in response to changing conditions. The ATS 380 makes use of the traveler's scheduling application to trigger the booking of travel and accommodates the traveler's normal work flow by automatically embedding details regarding the trip into the scheduling application. The traveler's scheduling application then becomes the traveler's itinerary. The air flights, car rental, and hotel information may all be embedded into the traveler's scheduling application.

By managing the travel via the scheduling application, the ATS 380 is complementary to how most travelers work. Most individuals use their calendar as the basis of their time management. The ATS 380 allows the traveler to enter, modify, or cancel meetings and have their travel arrangements conveniently and automatically created without having to access a separate system. Consequently, the ATS 380 offers advantages from both time and cost perspectives to most business travelers as well as personal travelers. In addition, based on the traveler's preferences, the traveler may have travel arrangements automatically created or changed without any other human intervention, have travel arrangements created or changed only after the traveler's confirmation, or to have trip information created without any actual reservations created or until the trip is approved by the company with which the traveler is associated.

The ATS 380 may also accommodate emergency situations requiring immediate changes in travel arrangements. In both personal and business travel, emergency situations arise in which the traveler needs to immediately make travel changes to respond to the situation at hand. Such emergency situations may be, for example, medical emergencies, political unrest, or other military or terrorist actions in the traveler's current or anticipated area, severe personal family situations in which the traveler must return home, acts of God such as earthquakes, hurricanes, tornados, flooding, or tsunamis, financial collapse of a region, situations of immediate peril by being at a specific location or region, and any other such event that would warrant immediate travel with a strong disregard for the cost of such travel. The emergency travel may call for any suitable action, such as to get the traveler home, to get out of the location or region, to avoid already booked legs of a trip that will take the traveler to dangerous locations or regions that may put me in additional danger, to get to immediate medical help or specialty medical help, to get to an additional location of great importance, and/or generate a notification that the traveler is being held hostage and forced to make such arrangements.

The personal traveler would normally deal with such a situation by booking reservations and incurring the charges to their own credit cards. However, the personal traveler may be in peril and may not be able to reach the airport or other such point of departure, or the point of departure itself may be unsafe. Business travelers generally are constrained by corporate rules regarding making travel changes without approval, which may be likewise implemented by the ATS 380 in conjunction with the corporate profile 310. Most corporations have instituted such policies to prevent unnecessary charges and frivolous unmonitored upgrades. Failure to allow such travel changes when an employee-traveler is in immediate or potential danger or immediate need of medical attention which cannot be obtained locally, however, presents a situation in which such rules are counterproductive.

The ATS 380 may allow generation, cancellation, and/or modification of travel arrangements in emergency situations, such as to allow a traveler, or a proxy for the traveler, to make new or alter existing travel arrangements without prior approval and thus override any rules within the corporate profile 310. For example, the ATS application 130 may accept creation and changes to ordinarily unauthorized travel arrangements upon acceptance of an emergency code or other type of emergency request. The emergency code and/or request may be provided in any appropriate manner, such as via IVR, ASR, SMS, online forms, or metadata entered into the scheduling application or embedded in SMS or other communications. The emergency request may require submission of a reason for such changes and/or entry of a special code, and the ATS application 130 may perform a confirmation protocol to establish that the emergency conditions are genuine, such as via two-way communications to the traveler.

The ATS application 130 may use the reason information and any entered code to authorize the new adjusted travel arrangements. The ATS application 130 may further automatically inform appropriate business personnel as well as any family members that such travel or changes have been requested and booked, and of the nature of the situation.

Furthermore, the ATS application 130 may consider emergency conditions when generating the adjusted travel arrangements. For example, for a traveler flying out of a location or region or avoiding flying or traveling into or through other locations of unrest or danger, the ATS application 130 may utilize information from government and/or other travel databases to avoid certain areas, and can also conveniently and automatically use information input from the traveler. The travel changes may be made and the ATS application 130 may employ all means of confirming and communicating those changes to inform the traveler. The ATS application 130 may also facilitate procuring insurance for such unseen costs automatically on the booking of the travel or by requesting such insurance by embedded metadata codes into the travel request made by the traveler or the approver.

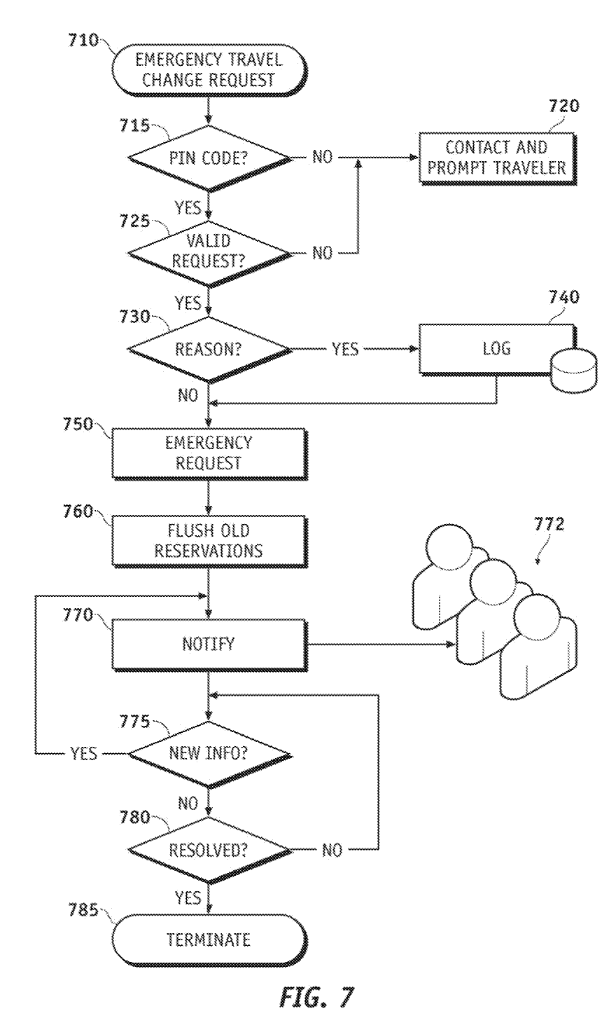

In one embodiment, referring to FIG. 7, an emergency travel request may be received by the ATS application 130 from the traveler or a proxy acting on behalf of a traveler (710). For example, an SMS message of “911 1234 Home Illness” may be sent to the ATS application 130. The “911” indicates that it is an emergency, the “1234” in this example is a traveler PIN, the keyword “home” indicates to get them home as soon as possible, and the reason may be one or more words that follows, such as an illness in this case. The inclusion of “911” triggers the emergency protocol in the ATS application 130. The traveler's PIN of “1234” in this example may be validated at to prevent a false request to the system (715). If the PIN is invalid, the ATS application 130 may alert personnel to contact the traveler or the ATS application 130 may automatically contact the traveler to determine whether the request is valid and help is required (720). If the PIN is valid, then the request is validated (725).

The request in this example is “Home”, which indicates to get the traveler home. If the keyword is not recognized, the ATS application 130 may contact the traveler to clarify the nature of the requested assistance. The reason code or keyword 730 may be included in the request 710 (730). In this case, the word “Illness is captured” and logged (740). The request to get the traveler home as soon as possible is executed (750).

Existing travel that is not needed anymore is cancelled (760). This includes all pending travel, including but not limited to flights, hotels, cars, and other specialized arrangements. Because this is an emergency situation, those specified in the travelers profile as emergency contacts 772 along with any business personnel are notified (770).

In an emergency situation, new information may be received by the ATS application 130 regarding the confirmation of the emergency travel request or comment information from the traveler. The ATS may continue to monitor for such information (775). If there is new information, the information may be transmitted to the traveler and other interested parties. When the traveler has arrived home and the emergency has been resolved (780), the emergency travel request sequence is terminated (785).

The ATS 380 may further facilitate automatic pre-approval, approval, and tracking of charges directly or indirectly associated with traveler. For example, various expenses may be known before the travel begins, while other expenses may occur during the travel and need to be expeditiously approved to enable the business traveler to make changes to the travel based on external elements, such as business meeting changes, additional legs of a trip added, and even weather or other acts of God not foreseen in the original approved trip.

The ATS 380 may map charges to specific accounts and uses, such as:

Pre-approval of all travel and expense.

Post approval of all expenses, travel and non travel, incurred during a trip.

Meeting or event changes that do not affect travel. Such charges ordinarily have no impact or and do not need re-approval unless the employee is needed someplace else on the new date/time.

Meeting or travel changes which require changes to be made to the travel itinerary. These changes may need to be approved before the traveler can continue their trip.

All expenses for a given trip to be charged to a specific charge number or credit card account.

Specific legs of a trip to be charged to a specific charge number or credit card account.

A specific type or travel or expense to always be charged to specific accounts based on functionality. For example, all airline travel is to be charged to one credit card, all hotel travel is to be charged to another credit card.

All travel on a specific airline, a specific hotel, or similar item charged to a specific account or credit card for tracking and frequent flyer/frequent use points.

Client or project specific charges may be mapped to specific accounts or credit cards. For example, a customer may request 1000 copies of a given report to be printed, bound and mailed to various personnel. This specific charge may need to be recorded so the expense is billed to that client.

The ability to have charges made to specific accounts or credit cards while having a separate tracking account for the expense. An example would be all expenses on the trip are charged to a specific credit card but various itemized expenses during the trip are itemized and recorded for internal tracking or for reconciliation of expenses later. An example would be the breakout of business entertainment expenses from travel expenses during a trip.

The ability to break out personal charges from business charges within a given trip or for all cases. Examples would be that an entire trip is paid for by the company but the airline charges for the traveler's wife are charged to a specific personal credit card, or the traveler has chosen to have dry cleaning performed by the hotel and the charge is to be made to the traveler's personal account.

Reconciliation of non-business charges at the end of the trip. This allows the traveler to receive an itemized listing of all charges at the end of a trip. They may annotate the charges via metadata or pull down menus allowing them to direct the charges to specific accounts. Including both business and personal accounts.

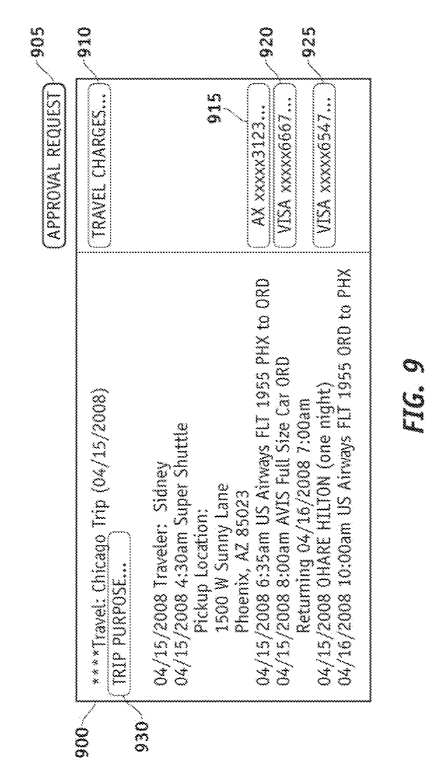

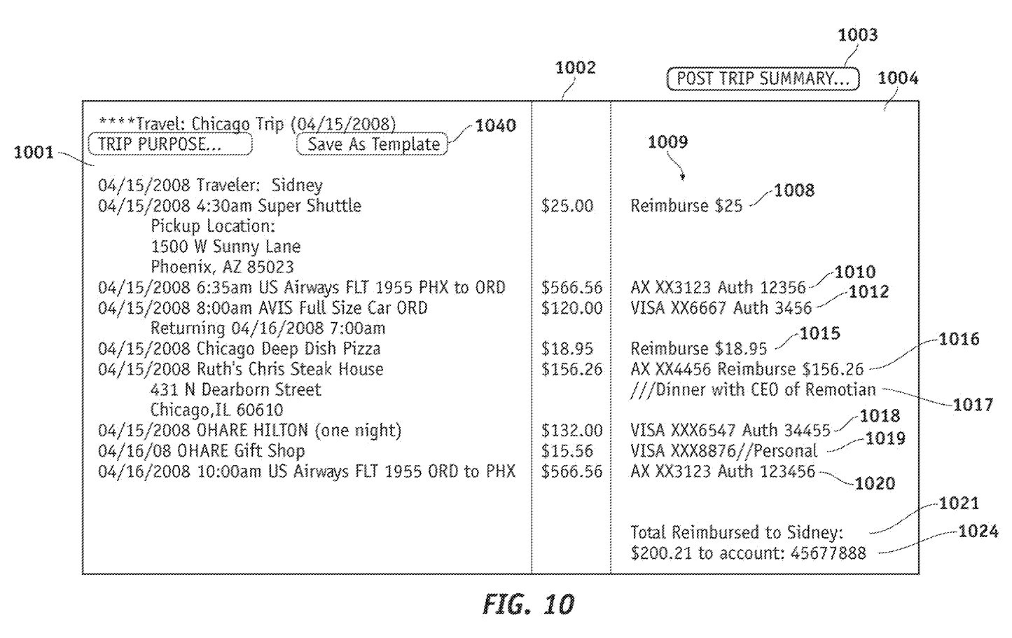

For example, referring to FIGS. 9 and 10, when a user creates an account, the traveler profile 320 may include form entries to allow the traveler to specify credit cards and other charge accounts. The traveler profile 320 may also include provisions allowing the traveler to enter banking account numbers so that reimbursed monies can be directly deposited into the personal accounts. Furthermore, various credit cards can be specified for different types of travel. For instance, a Southwest Airlines credit card may be entered and all travel on Southwest may be charged to that credit card account.

A credit card may be entered to be used for all airline travel. A separate credit card may be entered for car rentals, and yet another credit card may be entered for hotel and other lodging expenses. A personal credit card may be entered and used to move any personal charges to such a card as well as to move charges against any company credit card to a personal card if personal charges have been occurred against such a card.

Once a trip has been created, it may automatically be routed to a person to authorize a trip. Once an initial trip has been defined, an approval request form 900 may be provided to the traveler. The approval request form 900 may provide details for travel as an itinerary with activity and charges associated with that travel. The traveler may define the purpose of the trip by depressing a button 930, which would allow the traveler to enter additional text. Further, if the trip approval was not automatically transmitted for approval, the traveler may define the approvers and allow the document to be sent to those individuals by depressing the APPROVAL REQUEST button 905.

To define that all bookable charges go to a specific account, the traveler may select a TRAVEL CHARGES button 910, which allows the traveler to define an account for all the travel to be charged against. The traveler may, however, choose to charge various portions of the trip to various accounts. For example, the traveler may select different credit cards or other accounts 915, 920, 925 to associate with various charges, such as by using drop down menus or hyperlinks. In this example, the traveler has shown the airline flight is to be charged to American Express, and the car rental and hotel rental to be charged to two separate VISA accounts.

As a shortcut alternative to viewing and submitting a form, the traveler may alternatively embed metadata within the meeting invitation body or in a free format field of the travel client on the traveler's personal computer. The metadata allow for not only trip preferences to be defined, but for the trip approval to occur. For example, a traveler in Phoenix is invited to a meeting in Chicago in a week. The traveler may embed metadata such as “//Book Travel; Approval: clark@remotian.com.” The ATS 380 may then automatically attempt to book the trip to Chicago based on the time and date of the meeting and on the preferences defined within the traveler profile 320. The tentative trip itinerary and projected charges are routed to “clark@remotian.com.” Once the embedded form is approved, the trip would be booked and the information sent to the traveler.

Once a trip has occurred, the traveler may have to reconcile any charges associated with the trip, such as in conjunction with a summary report 1001. The summary report 1001 may include any suitable information, such as not only the expected charges in the approval request form 900, but a detailed list of all charges and the amounts of those charges 1002 to the known credit cards or accounts during the trip. The credit or account information 1004 may be listed as well.

A graphical user interface control 1003 allows the user to select the specific form or trip information desired. Clicking on this control opens a detail menu showing the trip to view. In the present embodiment, the traveler has charged $25 to a personal card or has paid the shuttle from personal cash (1008). The traveler may enter such cash transactions during the trip, such as using the meta-commands. For example, the traveler may have simply entered “//Super Shuttle 4/15 $25.00” as text in the meeting body of the calendar or other scheduling application, in the client travel application, via an SMS message to the system or via a form, ASR, IVR, or even to a special email address to the travel system during the trip. In our example, the ATS 380 acknowledges that the notification of the expense has been received and indicates that the user is to be reimbursed $25 (1009).

An airline charge may be applied to a credit card (1010). The credit card is registered as part of the traveler profile 320 or as part of the corporate profile 310 associated with the account. The credit card was charged with the booking of the air flight. The return flight charges may be shown as well 1020. The rental car was specified to be charged to a separate credit card (920), and the associated charge included in the summary report 1001 along with any authorization code (1012).

The summary report 1001 includes another charge $18.95 for lunch (1015). For example, the traveler may have sent an SMS message “//Lunch Chicago Deep Dish Pizza $18.95” to the ATS 380. The out-of-pocket expense may be shown in the summary report 1001 along with the word “Reimburse”, indicating that the traveler is to be reimbursed for the expense (1015).

The summary report 1001 may include a dinner expense of $156.26 (1016). Business dinners of this amount would normally need to be justified. The traveler in this example may indicate the reason for the expense by simply typing a metadata comment in the summary report 1001, such as “///Dinner with CEO of Remotian” (1017). The comment may be visible to anyone approving the trip charges.

In the approval request form 900, hotel charges were specified to be charged to another credit card. The hotel expenses are shown in the summary report 1001 along with a partial card number and authorization code (1019).

While at O'Hare airport, the traveler made a purchase at a gift shop of $15.56 using a company credit card. To have those charges reimbursed by the traveler/employee, the traveler may type a metadata phrase next to the charge. In this case, the traveler added “//Personal” (1019), which may direct the ATS 380 to charge the traveler personally for the expense, such as via a pay deduction and/or reduction from reimbursements. In this example, the charge of $15.56 to the company credit card is reconciled by having it automatically reimbursed by the traveler.

The traveler “Sidney” is shown the amount of the reimbursement (1021). In this case, $200.21 which is to be credited to the account 456778881 (1024). Because the summary report 1001 may include metadata, the traveler may use such data to control charges to various accounts or users. In some cases, the traveler may want all charges to be charged to one credit card. For internal purposes, however, the traveler may desire to track certain charges related to a certain client, project or product. In this case, the traveler may enter “//Track Account 12345” or “//Track Marketing-Leads”. In this case, the expense would be placed in a database account named “12345” or “Marketing-Leads”. The traveler may create these names spontaneously for convenience and time management

The summary report 1001 may also include a control option designated “Save As Template” 1040. When selected, the ATS 380 may automatically review previous trips when creating new bookings for the traveler. If the traveler is satisfied with the arrangements of this trip, however, then the next time the traveler is making travel arrangements, the saved information may be used in conjunction with any preferences they have defined in the traveler profile 320 as well as any travel constraints defined by the corporate profile 310 to book similar arrangements.

The overall experience of the traveler is that the travel arrangements are conveniently and automatically created for them with minimal user interaction. If changes are desired by the traveler, multiple systems for interacting with the ATS 380 are available to make such changes, and if there are changes in the travel, such as a flight delay, the traveler is notified by any or all means that they have specified. In an emergency situation, the traveler has options to override normal corporate constraints.

For charges and tracking costs of travel, the traveler is conveniently presented with both pre- and post-travel summaries that can allow for the easy reconciliation of charges as well as concurrently managing both personal and business expenses in a single interface. Additional metadata can be created with similar names to facilitate such travel arrangements, allowing travelers to customize their travel experience and allow for travel changes to occur without their direct involvement.

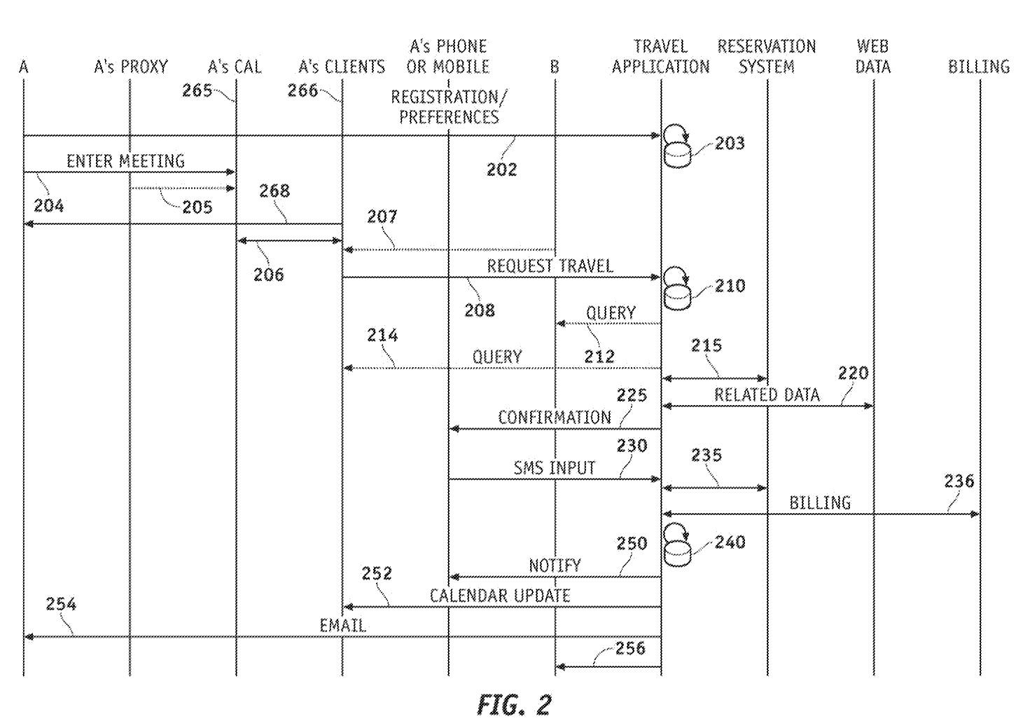

In operation, referring to FIG. 2, traveler A may wish to use the ATS 380. Traveler A has a scheduling application, such as an electronic calendar 265. To use the ATS 380, traveler initially creates an account and provides inputs, such as travel preferences for the traveler profile 320 (202). The travel preferences may include any suitable information, such as airline preferences, frequent flyer numbers, airline seating such as aisle or window, business class, first class, or coach, airline meal preferences, special needs such as, but not limited to, wheelchairs or meal restrictions, hotel preferences, smoking preferences when they apply, rental car preferences and rental car frequent user awards numbers, information on sporting or cultural events when traveling to various locations, refundable fair information, lowest cost fair or direct fair, travel day preferences such as Monday morning rather than Sunday night and other such information which would assist the traveler in any way. The user would also enter information for billing such as credit card numbers and in some cases direct billing to a company or other third party. The traveler may register via any appropriate mechanism, such as from a secure web interface. The traveler information is securely stored, such as in the traveler profile 320 (203). If appropriate, the traveler may also download or otherwise receive a client travel application 370 (266) that facilitates interaction between the electronic calendar 265 and the ATS 380.

Traveler A may create a meeting with a person, such as by entering the meeting data into the electronic calendar 265 (204). Alternatively, a person acting as a proxy for Traveler A may create a calendar entry (205). The ATS 380 and/or the client travel application 370 may review the calendar entries and determine whether arrangement should be made. The ATS 380 may also review information pertaining to the other invited participants, such as participant B (207). If all travelers are in Phoenix, then travel arrangements may not be needed. On the other hand, all of the participants may be located in Phoenix, but they may all be attending a convention in San Jose. In this case, the ATS application 130 and/or the client travel application 370 may attempt to note such information from the calendar text and automatically schedule or prompt the user for the location information if it is ambiguous (268). The ATS 380 can also attempt to coordinate the travel of all travelers.

In the present embodiment, when the client travel application 370 determines that travel is needed, the client travel application 370 passes the request to the ATS application 130, for example by consuming a web service on an Internet accessible server (208), where the request stored (210). The input of the request may be handled internally by an event manager program running on the ATS.

The request may be analyzed by an event coordinator program also running on the ATS 380, which examines the request. Depending on accessible calendar information about others traveling to the same location at the same time or others attending the same meeting, the event coordinator program may make requests for such calendar data, such as a query to participant B's calendar (212). If participant B is part of a company that has an Internet accessible back office server running Microsoft exchange or similar system, a query may be made to that server to also examine other travelers' calendars (214).

The ATS 380 may also access various services to complete the travel arrangements. Depending on the traveler's preferences and corporate travel preferences and rules, the trip may be automatically scheduled without any other confirmation. The ATS 380 first accesses reservation systems (215) to determine availability and cost of airlines, hotels, cars or any other needed or requested arrangement. The ATS 380 may also concurrently request information about weather, travel warnings, maps, cultural or sporting events via the Internet (220) and provide this information to the traveler, such as via embedded media or via links to the Internet or to the ATS 380.

The information may be provided to the traveler, such as in a format preferred by the traveler based on the traveler's preferences. For example, the traveler may carry a Short Message Service (SMS) enabled cell phone, in which case the ATS application 130 may package the message by asking for the traveler's choice and confirmation in an SMS message. The user may have previously elected to always have non-stop flights by entering such information in the traveler profile 320. The traveler may, for example, accordingly be shown three non-stop flight options in an SMS message transmitted to them (225).

The traveler may respond, such as to identify one or more selections or request changes. In this example, the traveler may respond with an SMS message indicating the traveler's selection (230). The ATS 380 may confirm the reservation (235) with arrangements that are needed such as a round trip airline ticket, a car, and a hotel. Depending on the billing arrangements, the charges may be automatically made to a billing provider such as a credit card company (236). The itinerary and all of the other collected information such as maps and cultural events may be packaged together and stored (240).

The ATS 380 may notify the user with all of the information pertaining to the trip via the various communication mechanisms specified in the traveler profile 320. In the present example, the confirmation is provided to the traveler's cell phone (250), by email (254), and is also provided to other participants (256). The traveler's calendar may be updated with the information as well (252), such as by transmitting the information to the traveler's client travel application 370, which may write the information into the electronic calendar 265. The electronic calendar 265 may be marked with embedded information so that cancellations or changes to the meeting automatically trigger stored information pertaining to that meeting and automatically associate it with the known scheduled trip.

Cancellations or changes to any meeting may be similarly handled. The traveler may at any time initiate changes by modifying the electronic calendar 265 information, by keyword commands in SMS, chat or similar text messages to the ATS 380, or by other systems such as Interactive Voice Response (IVR) or voice command input using Automatic Speech Recognition (ASR). Intelligent mobile applications providing real time tracking of the traveler with real time information are also possible with the ATS 380. Rich multimodal applications providing both voice and visual input can also be fully supported with future handheld devices.

In one example of a travel change occurring while the traveler was still on the plane, the traveler may land and be notified of changes to the schedule. The traveler may not be required to approve such changes or respond to the ATS 380. With internet connectivity on commercial aircraft, such notifications may be provided while the traveler is en route. In either case, the travel changes may be made automatically and the traveler may be conveniently and automatically notified about the changes by suitable notification, such as via SMS, text messaging, or email.

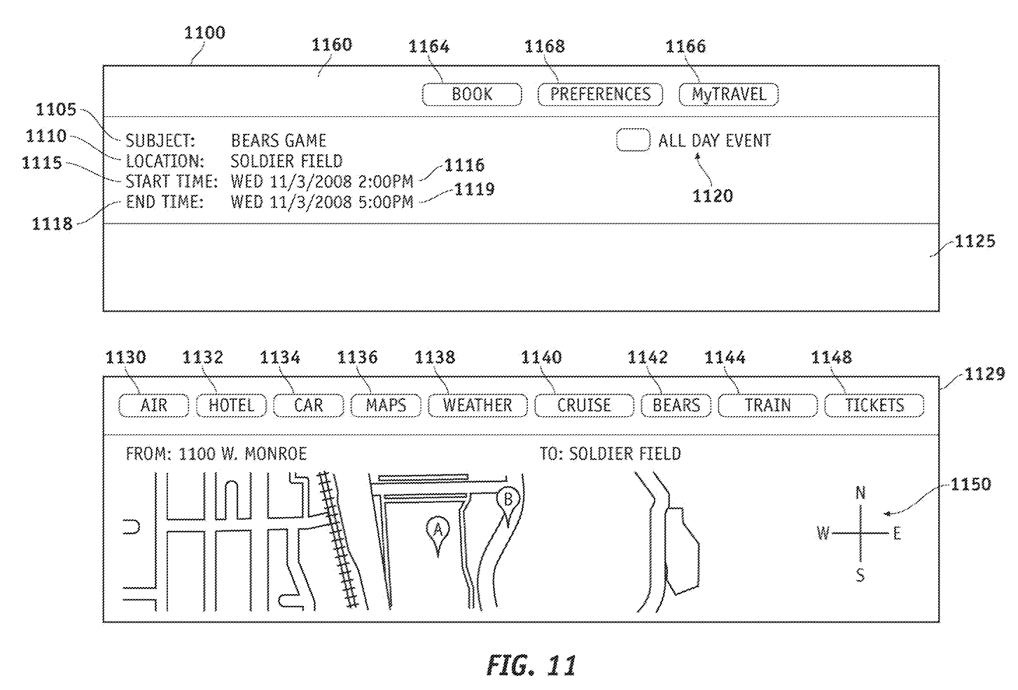

Referring to FIG. 11, another example illustrates the interaction of the scheduling application, the client travel application, and/or the ATS 380 to automate many aspects of the users travel. Unlike traditional travel applications which force the user to specify the specific details of each trip, the present exemplary travel system allows the user to enter minimal information about an event or meeting and easily create arrangements for all aspects of the trip.

An exemplary travel calendar screen 1110 as viewed by a traveler includes a subject field 1105, a start date 1115, an end date 1118, a start time 1116, and an end lime 1119. For convenience, the user may check an “All Day Event” check box 1120 to indicate that the event will last all day. A free format entry area 1125 allows a user to enter text and other file references pertaining to the scheduled event.

In one embodiment, the client travel application 370 is fully integrated within the scheduling application and user controls for this application are present in a “ribbon bar” 1160 at the top of the application. The “ribbon bar” 1160 may include one or more user controls related to the scheduling application. In another embodiment, the client travel application 370 is concurrently on the same machine as the scheduling application but it is not fully integrated within the scheduling application. The client travel application 370 may interact with the scheduling application data, such as to read from and write to the scheduling application. The client travel application 370 may provide a separate display for viewing the travel results.

The integrated client travel application 370 integrates three controls in this example, but may have more or less depending on the options the user selects during setup of the travel application. In the present “ribbon bar” 1160, there is a user control “Book” 1164 which is used to book travel, a “Preferences” 1168 control which allows the user to create, edit or delete user definable options, and a “MyTravel” 1166 control which allows the user to view all past, current, and future travel arrangements.

In the present example, the user wishes to attend a Chicago Bears Game at Soldier field in Chicago on Nov. 3, 2008. The users enters “Bears Game” in the subject field 1105, the location “Soldier Field” in the location field 1110, the start date Nov. 3, 2008 and time in the respective fields 1115, 1116, and the end date and time Nov. 3, 2008 5:00 PM in the respective fields 1118, 1119 respectively.

The user may select the Book button 1164 and a trip including the air travel, hotel, car, and tickets to the Bears Game are automatically obtained for the user and the results are displayed in another window or frame of the current window 1129. The window 1129 includes various controls or tabs, such as “Air” 1130 which may provide all information regarding the booked flights which were automatically or manually chosen based on the information “Bears Game”, “Soldier Field”, and the start and the end times shown.

If the user is going to need to stay overnight, the ATS 380 may arrange a hotel in the vicinity of downtown Chicago, such as based on geo-coding information of the location of the event, and is chosen by the ATS application 130 to be as close to the game as possible and within other predefined travel preferences the user may have defined within their user profile/preferences. Such hotel information may be viewed by selecting the “Hotel” tab/control 1132.

If a car is required, the ATS 380 has reserved the car and the information pertaining to the rental company may be found in the “Car” control/lab 1134. Likewise, the “Maps” control 1136 may provide maps 1150 from the airport to the city. The “Weather” control 1138 may present local and destination weather, as well as trip-specific information such as temperature at kick-off. Though a winter dinner cruise on Lake Michigan in November may be unpleasant, if a cruise is part of a trip, specific information pertaining to the ship and departure and arrival times may be accessed via a “Cruise” button control 1140.

Information specific to the trip, such as information about the game, the stadium, parking or transportation to the stadium may be accessed via the “Bears” button 1142. If the elevated train is to be used in Chicago, a map, costs, and times of the train in relation to the hotel, airport and event location may be accessed via the “Train” button 1144. The “Tickets” button 1148 may provide information pertaining to the tickets and “will call” or delivery information. Other tabs/controls may be shown depending on the travel location and event. Further examples include information on international travel, travel restrictions and warnings, and facilities for those handicapped or with special needs.

Thus, the user may enter the event by name, time and location and depress BOOK. All arrangements may be automatically completed by the ATS 380 without user interaction. If conflicts are detected, the ATS 380 and/or the client travel application 370 may prompt the traveler for clarification. For example, if the date was entered as Wed Nov. 3, 2008, the ATS application 130 may look up the actual game date and time and propose corrections to the traveler if the event and the entered date/time did not match.

Thus, the present exemplary system according to various aspects of the present invention provides mechanisms for the ATS 380 to act without physical human interaction and make choices for the traveler. In one embodiment, the ATS 380 may identify that a connecting flight had been cancelled and would automatically reschedule an alternate night, even on another carrier, so that the traveler could continue on the trip without delays. The ATS 380 may make and adjust travel arrangements according to the traveler's preferences and/or within the bounds of corporate or personal travel guidelines. The ATS 380 may make changes to the traveler's schedule without the traveler's acknowledgement, including but not limited to automatically creating, changing and even cancelling various arrangements such as airline reservations and car rental reservations.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles or the same.

1. A computer-implemented method for arranging travel, comprising:
automatically identifying appointment data associated with a scheduling application of a first participant for an appointment requiring travel; and
automatically researching a travel arrangement for first participant for the appointment according to the appointment data.

2. A computer-implemented method for arranging travel according to claim 1, further comprising automatically making the travel arrangement.

3. A computer-implemented method for arranging travel according to claim 1, further comprising automatically researching the travel arrangement for the appointment according to at least one of a traveler profile and a corporate profile.

4. A computer-implemented method for arranging travel according to claim 1, further comprising:
automatically identifying appointment data associated with a second scheduling application for a second participant of the appointment; and
automatically researching a travel arrangement for the first participant and the second participant according to the appointment data for the first and second participants.

5. A computer-implemented method for arranging travel according to claim 1, further comprising requesting an adjustment to the travel arrangement via a text-based communication.

6. A computer-implemented method for arranging travel according to claim 1, further comprising requesting an adjustment to the travel arrangement with an emergency override code.

7. A computer-implemented method for arranging travel according to claim 1, further comprising:
automatically monitoring the availability of the travel arrangement; and
automatically booking an alternative travel arrangement if the original travel arrangement becomes unavailable.

8. A computer-implemented method for arranging travel according to claim 1, wherein automatically researching the travel arrangement comprises researching the travel arrangements according to a travel template.

9. A computer-implemented method for arranging travel, comprising:
automatically analyzing data associated with a scheduling application for an appointment to identify a time and location for the appointment;
automatically identifying a possible travel arrangement for the appointment;
receiving an approval for the possible travel arrangement;
automatically booking the travel arrangement in response to the receipt of the approval; and
automatically updating the data associated with the scheduling application with information for the booked travel arrangement.

10. A computer-implemented method for arranging travel according to claim 9, further comprising automatically identifying the possible travel arrangement for the appointment according to at least one of a traveler profile and a corporate profile.

11. A computer-implemented method for arranging travel according to claim 9, further comprising:
automatically analyzing appointment data associated with a second scheduling application for a second attendee of the appointment; and
automatically researching a travel arrangement for the first participant and the second participant according to the appointment data for the first and second participants.

12. A computer-implemented method for arranging travel according to claim 9, further comprising requesting an adjustment to the travel arrangement via a text-based communication.

13. A computer-implemented method for arranging travel according to claim 9, further comprising requesting an adjustment to the travel arrangement with an emergency override code.

14. A computer-implemented method for arranging travel according to claim 9, further comprising:
automatically monitoring the availability of the travel arrangement; and
automatically booking an alternative travel arrangement if the original travel arrangement becomes unavailable.

15. A computer-implemented method for arranging travel according to claim 9, wherein automatically researching the travel arrangement comprises researching the travel arrangements according to a travel template.

16. A computer system for arranging travel, wherein the computer system is configured to:
automatically identify appointment data associated with a scheduling application of a first participant for an appointment requiring travel; and
automatically research a travel arrangement for first participant for the appointment according to the appointment data.

17. A computer system for arranging travel according to claim 16, wherein the computer system is further configured to automatically make the travel arrangement.

18. A computer system for arranging travel according to claim 16, wherein the computer system is further configured to automatically research the travel arrangement for the appointment according to at least one of a traveler profile and a corporate profile.

19. A computer system for arranging travel according to claim 16, wherein the computer system is further configured to:
automatically identify appointment data associated with a second scheduling application for a second participant for the appointment; and
automatically research a travel arrangement for the first participant and the second participant according to the appointment data for the first and second participants.

20. A computer system for arranging travel according to claim 16, wherein the computer system is further configured to request an adjustment to the travel arrangement via a text-based communication.

21. A computer system for arranging travel according to claim 16, wherein the computer system is further configured to request an adjustment to the travel arrangement with an emergency override code.

22. A computer system for arranging travel according to claim 16, wherein the computer system is further configured to:
automatically monitor the availability of the travel arrangement; and
automatically book an alternative travel arrangement if the original travel arrangement becomes unavailable.

23. A computer system for arranging travel according to claim 16, wherein the computer system is configured to automatically research the travel arrangement according to a travel template.

24. A medium storing instructions for causing a computer to implement a process for arranging travel, the process comprising:
automatically identifying appointment data associated with a scheduling application of a first participant for an appointment requiring travel; and
automatically researching a travel arrangement for first participant for the appointment according to the appointment data.

25. A medium storing instructions according to claim 24, the process further comprising automatically making the travel arrangement.

26. A medium storing instructions according to claim 24, the process further comprising automatically researching the travel arrangement for the appointment according to at least one of a traveler profile and a corporate profile.

27. A medium storing instructions according to claim 24, the process further comprising:
automatically identifying appointment data associated with a second scheduling application for a second participant of the appointment; and
automatically researching a travel arrangement for the first participant and the second participant according to the appointment data for the first and second participants.

28. A medium storing instructions according to claim 24, the process further comprising requesting an adjustment to the travel arrangement via a text-based communication.

29. A medium storing instructions according to claim 24, the process further comprising requesting an adjustment to the travel arrangement with an emergency override code.

30. A medium storing instructions according to claim 24, the process further comprising:
automatically monitoring the availability of the travel arrangement; and
automatically booking an alternative travel arrangement if the original travel arrangement becomes unavailable.

31. A medium storing instructions according to claim 24, wherein automatically researching the travel arrangement comprises researching the travel arrangements according to a travel template.
